(19) United States
(12) Patent Application Publication
(10) Pub. No.: US 2002/0174169 A1
(43) Pub. Date: Nov. 21, 2002

(54) Process for operating a distributed computer network comprising several distributed computers

(76) Inventor: Hans Albrecht Schmid, Allensbach (DE)

Correspondence Address: HOFFMAN WASSON & GITLER, 2361 JEFFERSON DAVIS HIGHWAY, SUITE 522, ARLINGTON, VA, 22202

(21) Appl. No.: 09/905,184

(22) Filed: Jul. 16, 2001

(30) Foreign Application Priority Data
May 21, 2001 (DE) 101 24 930.6

(51) Int. Cl. G06F 15/16

(52) U.S. Cl. 709/201; 709/205

(57) ABSTRACT

The invention relates to a process for operating a distributed computer network. The computer network has several distributed computers, on one of the computers there being a component of a computer program, a component which can run on the microprocessor of the computer. To operate the computer the component is accessed from a collocated client or a remote client. To accelerate processing of the computer program, it is proposed that the component be accessed from the collocated client via the local gate of the component if the component is filed on the same computer and runs within the same execution environment as the client, and otherwise the component is accessed from the remote client optionally via a proxy via a remote gate of the component.

### BACKGROUND OF THE INVENTION

This invention relates to a process for operating a distributed computer network comprising several distributed computers. On one of the computers there is at least one component of a computer program, a component which can run on the microprocessor of the computer. To operate the computer the component is accessed from a collocated client or a remote client. The collocated client is filed on the same computer and runs within the same execution environment as the component. The remote client is filed on another computer and/or runs within an execution environment other than the component.

The invention furthermore relates to a process for operating a computer of a distributed computer network comprising the computer and several other distributed computers. On the computer there is at least one component of a computer program, a component which can run on the microprocessor of the computer. To operate the computer the component is accessed from a collocated client or a remote client.

The invention furthermore relates to a computer program which can run on the microprocessors of the computers of a distributed computer network. The computer program furthermore has at least one component with at least one gate for accessing the component from a collocated client or from a remote client.

This invention furthermore relates to a storage element for a computer of a distributed computer network. The storage element stores at least one component of a computer program which can run on the microprocessors of the computers of the computer network. The computer program has several components each with at least one gate for accessing the component from a collocated client or a remote client. Especially a read-only memory, a random access memory, or a flash memory can be used as the storage element.

The invention furthermore relates to a computer of a distributed computer network. The computer comprises a storage element, especially a read-only memory, a random access memory or a flash memory, on which at least one component of a computer program which can run on the microprocessors of the computers of the computer network is stored. The computer program has several components with at least one access each for accessing the components from a collocated client or a remote client.

Finally, this invention relates to a distributed computer network comprising several computers. The computers each have one storage element, especially a read-only memory, a random access memory, or a flash memory. The storage element stores at least one component of a computer program which can run on the microprocessors of the computers of the computer network. The computer program has several components with at least one gate each for accessing the components from a collocated client or a remote client.

The existing art discloses distributed components, for example objects or components distributed as so-called Enterprise Java Beans (EJB) or Common Object Request Broker Architecture (CORBA). In the known methods for processing of a computer program composed of distributed components on the computers of a distributed computer network the individual components each comprise different functionalities of the system environment (for example, EJB or CORBA) and application-specific functionalities. The distributed computer network consists of different computers or computer nodes. On one computer or computer node at least one software execution environment is implemented. The computer network has for example a client-server architecture.

To execute certain application-specific functions within the framework of processing of the computer program a client can access a certain component which has the desired application-specific functionalities. The client can for example be made as another component of the same computer program or as an optionally different computer program. When the client and the invoked component are implemented on the same computer and within the same execution environment, the client accesses the components within the framework of a so-called collocated invocation. This means that the client and the components are indeed located locally to one another, but in fact the access to the component is treated essentially like a so-called remote access. Otherwise the client within the framework of a remote access accesses the component. Requesting a certain service, invoking a function or method, or sending a message is called access to a component. In doing so parameters and/or results can be transmitted.

As already mentioned, in the prior art collocated access to a component is treated essentially as a remote access. But a remote access requires much more processing time than a local access since within the framework of remote access among others transformations and retransformations of information must be carried out for purposes of data transmission from one computer on which the client is implemented to another computer of the computer network on which the component is implemented. In collocated access to a component located on the same computer and in the same execution environment almost all functions which are necessary for a remote access are omitted.

The treatment of collocated accesses like remote accesses in the prior art is due to the known components having a remote interface with one remote gate. In this way location transparency can be ensured, i.e. the same component can be invoked both collocated and also remotely without reprogramming the client. A component with location transparency can be reallocated and easily moved from a local to a remote computer or computer network node and vice versa. Based on the remote interface however even collocated access to the component can take place via the remote gate, i.e. they are treated almost like remote accesses and require correspondingly as much processing time. Time-saving local access to a distributed component is therefore not possible in the prior art.

In the processes for operating a computer or a computer network which are known in the prior art limited optimizations of the collocated accesses are carried out. By these optimizations the access time for collocated accesses can be reduced compared to remote accesses, but they are still orders of magnitude greater than that for a local access.

In optimization of collocated accesses which is called collocation optimization, in a collocated access to the component the remote gate of the component is bypassed and branched directly into the component. In addition, by direct access to the component the system functionality of the remote gate is lost and must be invoked again only by special measures. This optimization is furthermore not suited for accesses to components, in which references to components must be transferred as parameters or results. In this optimization the components therefore have only limited location transparency.

Therefore the object of this invention is to accelerate the processing of a computer program with several components, which program can run on the microprocessors of the computers of a distributed computer network.

### SUMMARY OF THE INVENTION

To achieve this object, proceeding from the process for operating a computer network and from the processes for operating a computer of the initially mentioned type it is proposed that the component be accessed from the collocated client via a local gate of the component if the client is filed on the same computer and within the same execution environment runs like the component, and otherwise the component is accessed from the remote client via a remote gate of the component.

The components have one or more interfaces, therefore for each interface there being two separate gates, one local gate and one remote gate. In the component the functionalities which are necessary for remote access (prepared by the remote gate) are separated from the system-specific and application-specific functionalities (prepared by the local gate). The interface of the component is preferably made as a local interface which follows copier semantics (in contrast to reference semantics).

With the process as claimed in the invention the processing time of any distributed computer program with several components can be significantly reduced. This is done by the collocated accesses to one component taking place via the local gate and being treated as local accesses. In the local access the time-consuming functions necessary for remote access can thus be completely eliminated. The reduced processing time yields major cost advantages, since either with the same computer performance much more complex computer programs or more transactions than in the past can be processed or with the same complexity of the computer programs and number of transactions the computing power of the computers of the computer network can be reduced.

The process as claimed in the invention is optionally multi-stage processes, i.e. from the invoked component according to the suggested principle other components can be invoked and from them in turn other components can be invoked and so forth. According to one advantageous development of this invention it is therefore proposed that from the component at least one other component is accessed via a local gate of the other component, if the other component is filed on the same computer and runs within the same execution environment as the component and otherwise from the one component at least one other component is accessed via a remote gate of the other component.

In order to invoke a component from a collocated client of a computer network for example with client-server architecture, the client accesses the component via the interface and the local gate. Within the component then the system-specific (for example, EJB-specific or CORBA-specific) functionalities and the application-specific functionalities (which compute for example the result of a computer operation or the return value of a function invocation) are executed.

In order to invoke a component from a remote client of the computer network, the client accesses the component via the interface and the remote gate. Then the local gate is accessed internally from the remote gate. Within the framework of remote access first the remote gate executes the functionalities required for remote access before the local gate executes the system-specific (for example, EJB-specific or CORBA-specific) functionalities. Only then are the application-specific functionalities assigned to the component finally executed.

According to one preferred embodiment of this invention the remote gate of the components is accessed via a proxy, the proxy implementing the same interface as the local gate. Therefore the remote gate of the component is accessed from the client or another component indirectly via the proxy. In an access to the component via the local interface which makes available the proxy, the proxy must first convert the local interface into a remote interface for access to the remote gate. The local interface of the component is therefore implemented on the one hand by the local gate (technical implementation) and on the other by the proxy.

The use of the proxy leads theoretically to a slightly longer access time to the remote components than in the prior art. The additional access time is however, if present at all, negligibly small compared to the total duration of a remote access and is more than balanced by the greatly reduced access time in local accesses. On the average, with the process as claimed in the invention for processing of distributed computer programs via local and remote accesses to the components the processing times are much shorter than in the prior art.

According to this embodiment a client does not have a direct reference to a remote gate of the component or he will not use one such reference since otherwise there would no longer be location transparency, but he has a reference to a proxy which itself contains a reference to the remote gate. The proxy is located between the client and the remote gate of the component to be invoked so that the client always accesses the component via the same interface, regardless of via which gate access takes place in order to obtain this location transparency.

Advantageously the remote gate of the component is used for transformation of a parameter or a result if services or functionalities of the component have parameters or results which themselves represent a reference to another component and the other component is located locally with respect to the component, but remotely with respect to the client. If for example a local reference to a first component is to be relayed to a second component which is not collocated, the remote gate must transform the local reference into a proxy which refers to the remote gate of the corresponding component.

Furthermore, it is proposed that a proxy be used for transformation of a parameter or a result if services or functionalities of the component have parameters or results which themselves represent an indirect reference via another proxy to another component and the latter is located remotely with reference to the component, but collocated with reference to the client. Here the client and the other component are located in the same computer or computer network node and in the same execution environment.

According to another advantageous development of this invention it is proposed that to access a component first a local naming and directory service is accessed and from it a reference to the component to be invoked is transferred, the reference referring to a local gate of the component if the component to be invoked is a collocated component and the reference refers possibly via a proxy to a remote gate of the component if the component to be invoked is a remote component. The naming and directory service is a local list in which the names of the components of the computer program and local references to the components are filed. The remote references can be obtained from the local references. The remote references however can also be filed additionally to the local references in the naming and directory service.

According to another preferred embodiment of this invention, it is proposed that to access a component first a local naming and directory service is accessed and from this a reference to a factory of the component to be invoked is transferred, the reference referring the local gate of the factory if the factory and the component to be invoked are collocated, and the reference if necessary via a proxy refers to the remote gate of the factory if the factory and the component to be invoked are remote, and another reference to the component to be invoked is transferred by the factory, the other reference referring to a local gate of the component if the factory and the component to be invoked are collocated, and the other reference if necessary via a proxy referring to a remote gate of the component if the factory and the component to be invoked are remote. In EJB the factory is called a home interface. A factory is generally necessary when a component (for example, an account component) has more than one entity (for example, different accounts). The references from the local naming and directory service therefore need not necessarily directly point to a local or via a proxy to a remote gate of a component to be invoked. Rather it is also conceivable for the references to point first of all to the factory of the component to be invoked. The factory likewise has a local and a remote gate. Depending on whether the component to be invoked is implemented on the same computer and in the same execution environment as the invoking client or not, the reference points to the local or if necessary via a proxy to the remote gate of the factory. In the factory the other references to the local gates of the corresponding entities of the components to be invoked are filed. The remote references can be obtained from the local references. The remote references can however also be filed in the factory. The factory transfers either the local reference or a reference to the proxy to the invoking client which then invokes the component to be invoked via the reference.

As another approach to the object of this invention it is proposed proceeding from the computer program of the initially mentioned type that the component has a local gate for access to the component from the collocated client and a remote gate for access to the component from the remote client.

The component of the computer program as claimed in the invention is available both to a collocated and also a remote client. If the client is located in the same computer or computer network node and in the same execution environment as the component to be invoked, he is called the collocated client. If the client is located in another computer or computer network node or in an execution environment other than the component, he is called the remote client. The decisive advantage of the computer program as claimed in the invention is that as a result of the special configuration of the interface of the component with one local gate and one remote gate genuine local accesses to the component are only possible at all. In contrast to the collocated accesses known from the prior art, which are regarded and processed similarly to remote accesses, here there are genuine local accesses. In this way local accesses to a component take place much more quickly and the processing times for the computer program are much shorter.

The speed advantage in a local access arises especially by a collocated client not having to execute any additional functionalities which are necessary for a remote invocation (so-called remote invocation overhead) when the component is accessed within the framework of a local access. The local gate comprises all system-specific (for example, EJB-specific or CORBA-specific) functionalities and processes operation invocations from collocated clients. The remote gate comprises all functionalities necessary for remote access and processes invocations from remote clients. Furthermore, the computer program has full location transparency.

The computer program can also have several components each with one local and also one remote gate. Likewise each component can have several interfaces with several local and remote gates each. The components can be implemented in any distributed system environments, for example EJB or CORBA. With this invention in any systems the additional cost for the functionalities necessary for remote invocation (remote invocation overhead) for collocated accesses can be eliminated.

As another approach to the object of this invention it is proposed proceeding from the storage element of the initially mentioned type that the component has a local gate for access to the component from the collocated client and a remote gate for access to the component from the remote client.

As still another approach to the object of this invention it is proposed proceeding from a computer of the initially mentioned type that the component has a local gate for access to the component from the collocated client and a remote gate for access to the component from the remote client.

Finally, as another approach to the object of this invention it is proposed proceeding from the computer network of the initially mentioned type that the component has a local gate for access to the component from the collocated client and a remote gate for access to the component from the remote client.

### BRIEF DESCRIPTION OF THE DRAWINGS

Other features, possible applications and advantages of the invention arise from the following description of embodiments of the invention which are shown in the drawings. Here all the described features in and of themselves or in any combination form the subject matter of the invention, regardless of their composition in the claims or their reference and independently of their formulation or representation in the specification or in the drawings.

FIG. 1 shows a structure diagram of the invocation of a component of a distributed computer program within the framework of a process as claimed in the invention for processing of the computer program;

FIGS. 1bshows a structure diagram of the invocation of a component as shown in FIG. 1a from the standpoint of the client;

FIG. 2 shows a structure diagram of the invocations of a component of a distributed computer program within the framework of a process for processing of the computer program known from the prior art;

FIG. 3a shows a structure diagram of an access to a collocated component of a distributed computer program via a naming and directory service and a factory and a local invocation;

FIG. 3b shows a structure diagram of an access to a remote component of a distributed computer program via a naming and directory service and a factory and a remote invocation;

FIG. 4a shows a first scenario of the process as claimed in the invention with a collocated client and a reference to a collocated component;

FIG. 4b shows the scenario from FIG. 4a with a reference of the client to the collocated component;

FIG. 5a shows a second scenario of the process as claimed in the invention with a collocated client and a reference to a remote component;

FIG. 5b shows the scenario from FIG. 5a with a reference of the client to the remote component;

FIG. 6a shows a third scenario of the process as claimed in the invention with a remote client and a reference to a collocated component;

FIG. 6b shows the scenario from FIG. 6a with a reference of the client to the collocated component;

FIG. 7a shows a fourth scenario of the process as claimed in the invention with a remote client and a reference to a remote component;

FIG. 7b shows the scenario from FIG. 7a with a reference of the client to the remote component;

FIG. 8a shows a special case of the fourth scenario from FIG. 7a with a remote client and a reference to the remote component, the component being collocated to the client;

FIG. 8b shows the scenario from FIG. 8a with a reference of the client to the collocated component;

FIG. 9 shows components combined into different clusters;

FIG. 10 shows a facade component in detail; and

FIG. 11 shows a non-facade component in detail.

### DETAILED DESCRIPTION OF THE INVENTION

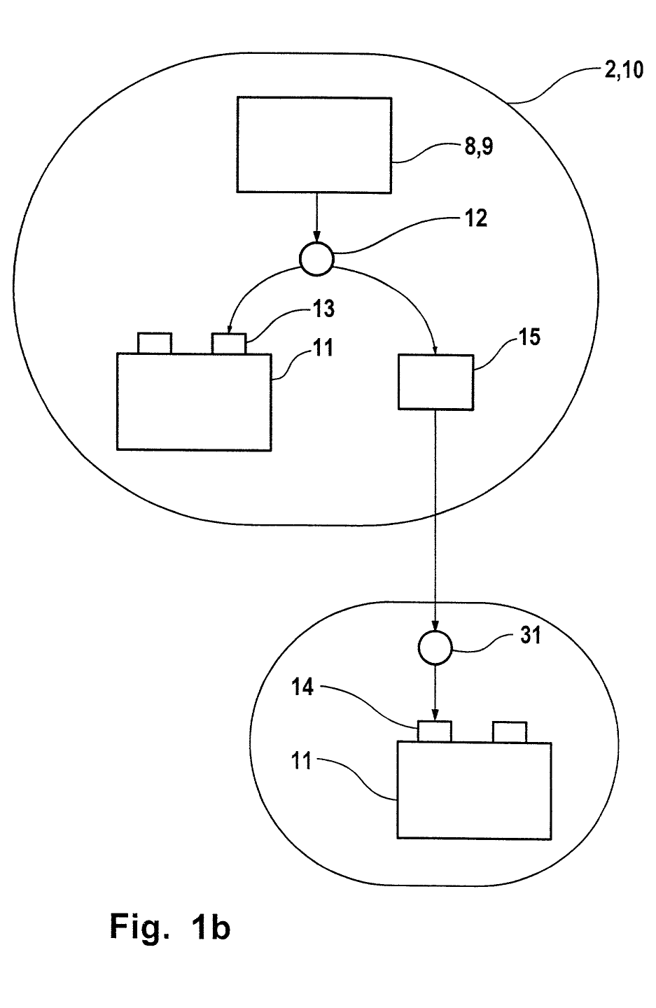

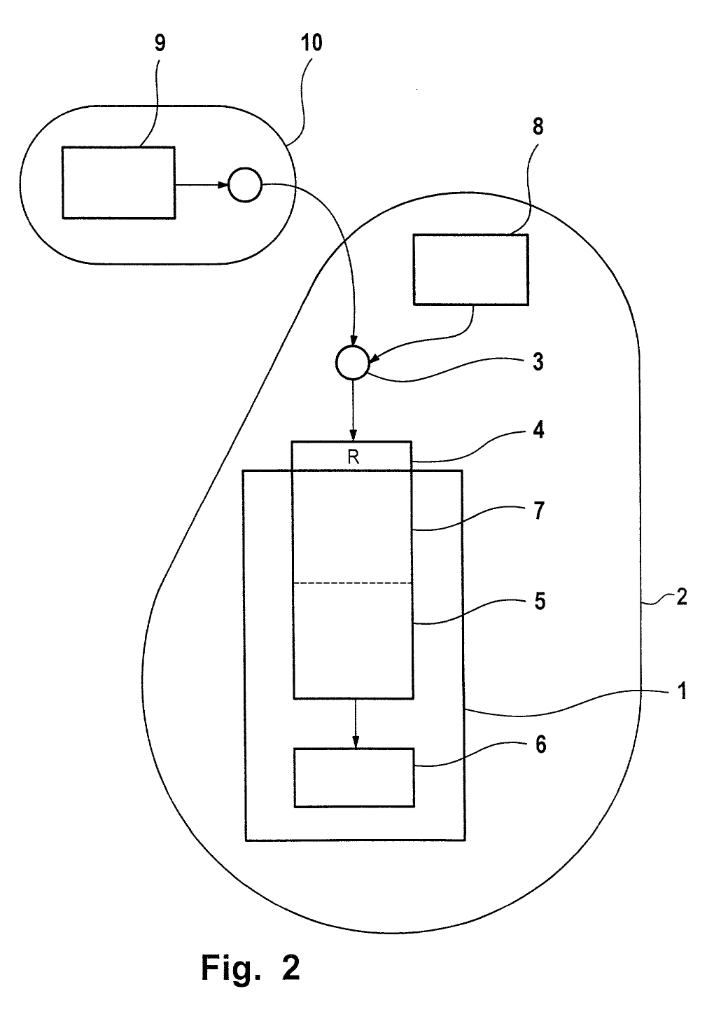

The existing art discloses computer programs with several components which can be run individually or severally on distributed computers of a computer network for example with a client/server architecture. The components are made for example as objects or components distributed as so-called Enterprise Java Beans (EJB) or Common Object Request Broker Architecture (CORBA). A component 1 known from the prior art is shown in FIG. 2. The component 1 is located on a computer or computer network node 2 of the computer network within a certain software execution environment. The component 1 comprises a remote interface 3 with a remote gate 4.

The component 1 has different functionalities 5 which are made available by the system environment (for example, EJB-specific or CORBA-specific functions) and application-specific functionalities 6 which correspond to the functions assigned to the component 1. In addition, the component 1 comprises the functionalities 7 necessary for a remote access via the remote gate 4. To execute the application-specific functions of the component 1 within the framework of processing of the computer program the component 1 is accessed by a collocated client 8 or a remote client 9. When the client and the invoked component 1 are implemented on the same computer 2 and within the same execution environment, it is called the collocated client 8. Otherwise the client is called the remote client 9.

The component 1 can be accessed by means of a collocated access (from the collocated client 8) or by means of a remote access (from the remote client 9). Access from the remote client 9 inherently requires much more time than access from a collocated client 8 since within the framework of remote access among others the functionalities 7 necessary for remote access, especially transformations and retransformations of parameters and results for purposes of data transmission between the computer 2 on which the component 1 is implemented and the computer 10 on which the client 9 is located, must be carried out. According to the prior art these additional functionalities 7 themselves must be carried out in a collocated access to the component 1 since collocated accesses to the component 1 take place via the remote gate 4. Thus collocated accesses are also treated essentially like remote accesses and require correspondingly as much computer time.

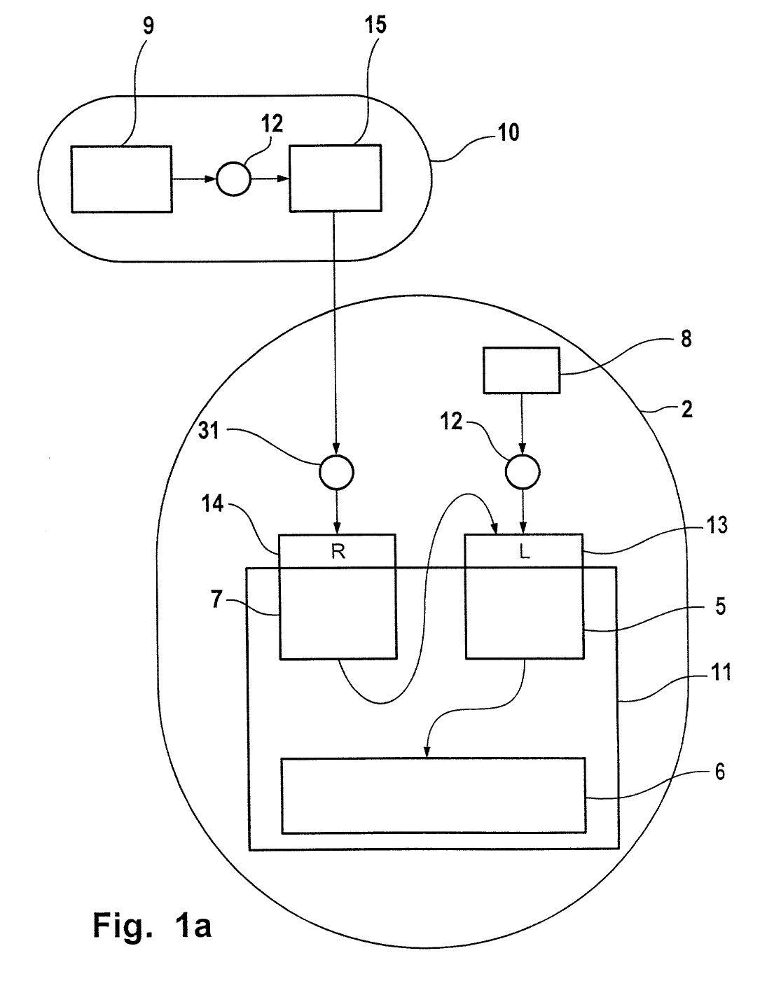

The component 11 of a computer program as claimed in the invention shown in FIG. 1a conversely has at least one local interface 12 with two separate gates at a time, one local gate (L) 13 and one remote gate (R) 14. The local gate 13 comprises all system-specific (for example, EJB-specific or CORBA-specific) functionalities 5 and processes operation invocations of collocated clients 8. The remote gate 14 comprises all functionalities 7 necessary for remote access and processes invocations of remote clients 9.

Processing of a computer program with several components, which program can run on the microprocessors of the computers of a distributed computer network, can be clearly accelerated by two gates 13, 14 of the component 11. As claimed in the invention the component 11 is accessed via the local gate 13 if the component 11 is located on the same computer 2 as the collocated client 8. Otherwise the component 11 is accessed from the remote client 9 indirectly via the remote gate 14.

The component 11 can be implemented in any distributed system environments, for example, EJB or CORBA. In any systems the additional cost for the functionalities 7 necessary for remote invocation (remote invocation overhead) for collocated clients can be eliminated by the invention. In the component 11 therefore the functionalities 7 which are necessary for a remote gate are separate from the system-specific functionalities 5 and the application-specific functionalities 6. The local interface 12 is on the one hand implemented by the local gate 13 (technical implementation) and on the other by a proxy 15.

In order to invoke the component 11 from the collocated client 8, the client 8 directly accesses the component 11 via the interface 12 and the local gate 13. Within the component 11 the system-specific (for example EJB-specific or CORBA-specific) functionalities 5 and the application-specific functionalities 6 are then executed. The functionalities 7 necessary for a remote access are not carried out for local access to the component 11.

In order to invoke the component 11 from the remote client 9, the client 9 accesses the remote gate 14 via the interface 12 and the proxy 15. The functionalities 7 necessary for a remote access are carried out there. Then the local gate 13 is accessed via an internal access. Then the system-specific (for example EJB-specific or CORBA-specific) functionalities 5 and the application-specific functionalities 6 are executed there.

There is a proxy 15 between the remote gate 14 and the remote client 9 in order to implement the local interface 12 for the client 9. The proxy 15 is an interface converter which in this case converts the local interface 12 into a remote interface 31 so that the client 9 can access the remote gate 14 of the component 11 via the local interface 12. The proxy 15 preserves the location transparency of the component 11.

FIG. 1b shows FIG. 1a from the viewpoint of the client 8, 9. The client 8, 9 sees the component 11 and the local interface 12 which is always the same regardless of whether it is implemented directly from the local gate 13 or via a proxy 15 and the remote gate 14.

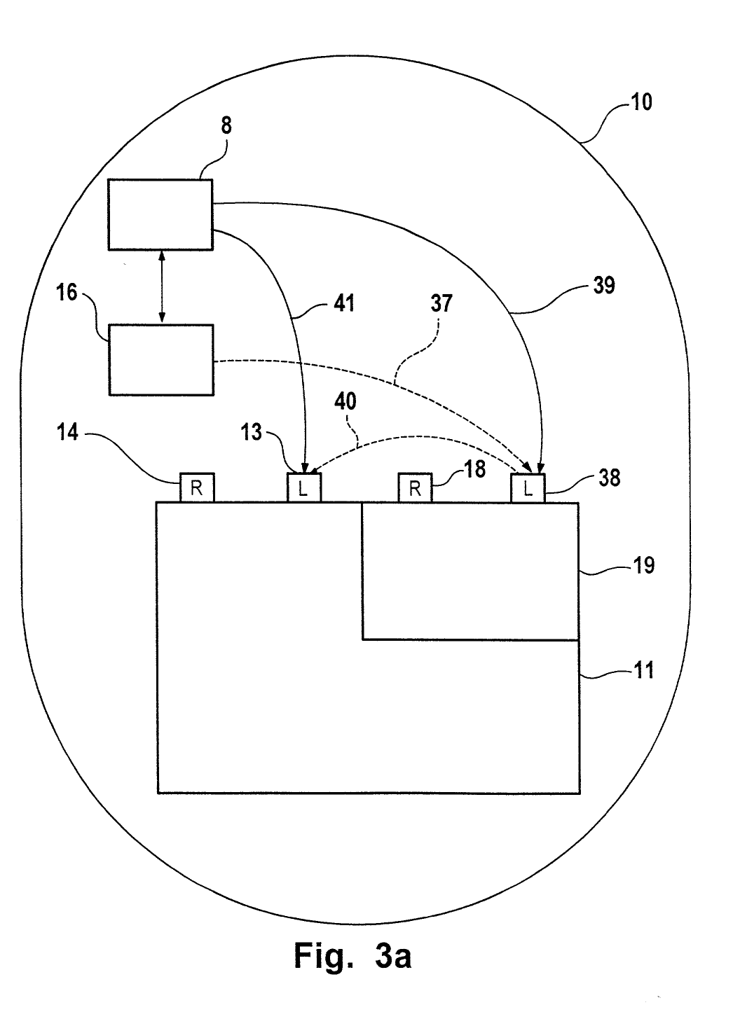

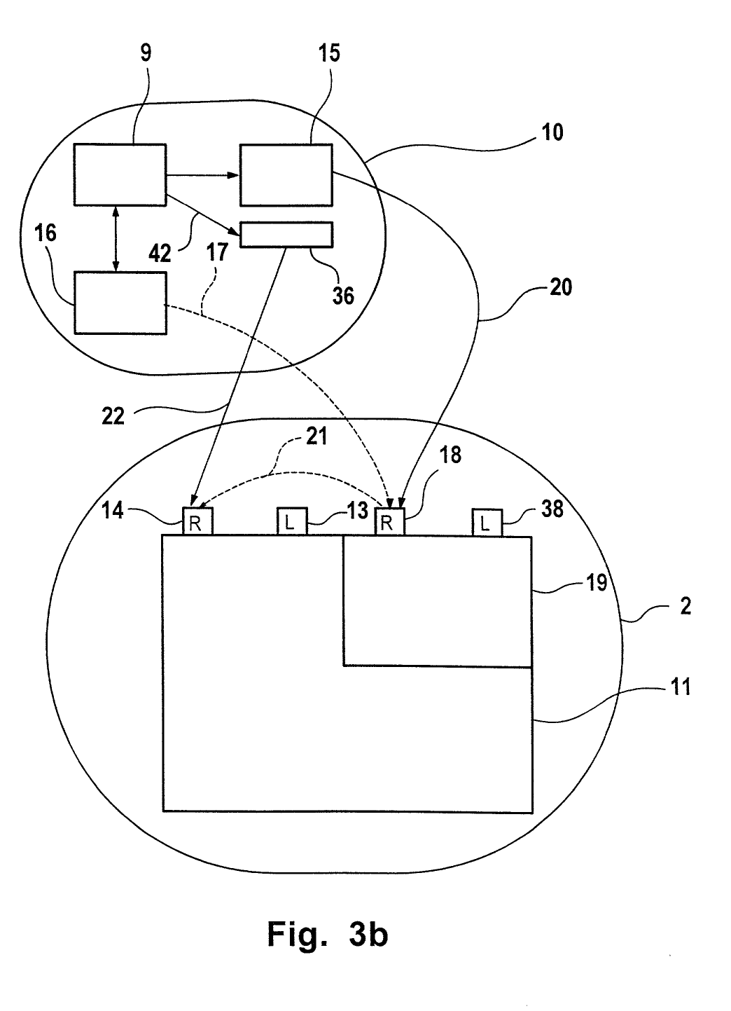

FIG. 3a shows a diagram of an access to a collocated component 11 of the distributed computer program with the pertinent factory 19 with the collocated client 8. In EJB the factory is also called the home interface. First the collocated client 8 accesses the naming and directory service 16 which is located locally to the client 8, i.e. on the same computer 10 and within the same execution environment. The naming and directory service 16 transfers a copy of the reference 37 to the local gate 38 of the factory 19 to the client 8. The client 8 keeps this as a reference 39 to the factory 14 and thus invokes its services. The factory 10 keeps a reference 40 to the local gate 13 of the component 11. The factory 19 transfers a copy of the other reference 40 to the local gate 13 of the component 11 to be invoked to the client 8. The latter keeps this as a further reference 41 and via it accesses the component 11.

FIG. 3b shows a diagram of an access to a remote component 11 of the distributed computer program with the pertinent factory 19 with the remote client 9. First the remote client 9 accesses the naming and directory service. The naming and directory service 16 transfers a proxy 15 with a reference 20 to the remote gate 18 of the factory 19 to the client 9. The client 9 keeps the reference 20 to the factory 19 via the proxy 15 and thus invokes its services. The factory 19 keeps a reference 21 to the remote gate 14 of the component 11. The factory 19 transfers a proxy 36 with another reference 22 to the remote gate 14 of the component 11 to be invoked to the client 9. The latter then accesses the component 11 via the proxy 36 and the other reference 22.

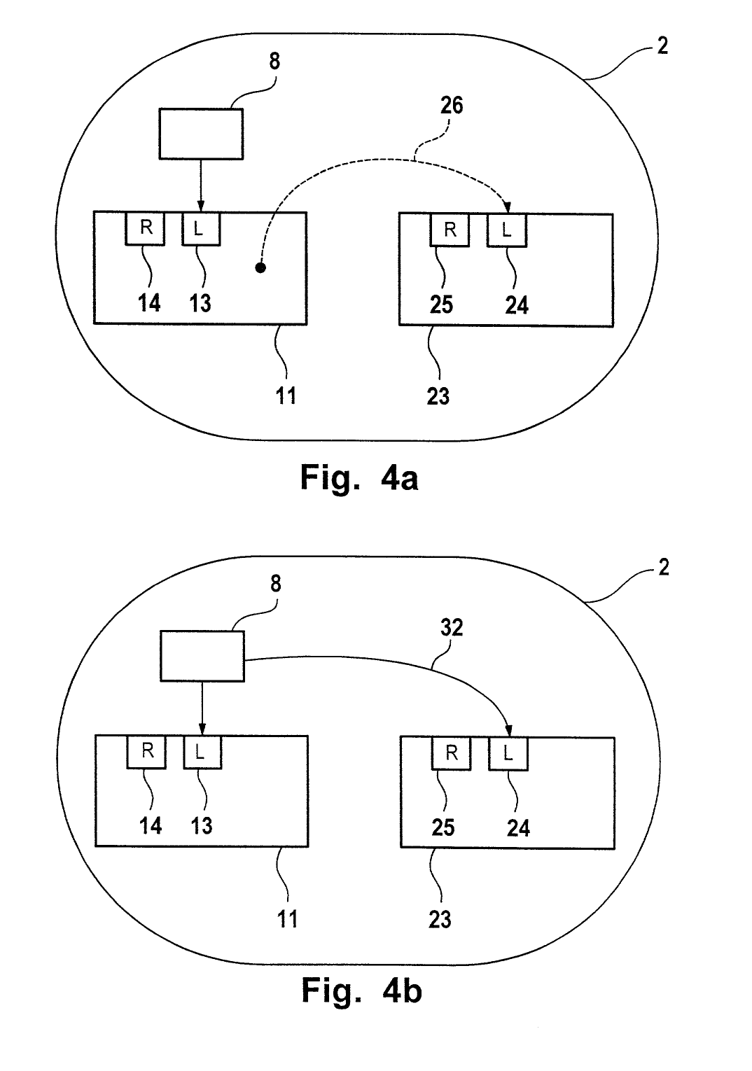

FIGS. 4 to 7 show four different scenarios of local or remote accesses to the component 11 and another component 23. The other component 23 likewise has a local gate 24 and a remote gate 25. The component 11 receives from a client 8, 9 a reference to the other component 23 either as the transfer parameters of a service invocation or returns it as a return parameter or as a result and must carry out if necessary a transformation.

In the first scenario from FIG. 4a the collocated client 8 via the local gate 13 accesses the component 11. The other component 23 is located in the same computer 2 or in the same computer network node and in the same execution environment as the component 11. The component 11 has a reference 26 to the local gate 24 of the collocated other component 23. This reference 26 is transferred to or from the client 8 which accesses the other component 23 via a reference 32 and the local access 24 (compare FIG. 4b). In the first scenario therefore no transformation of the reference parameters takes place.

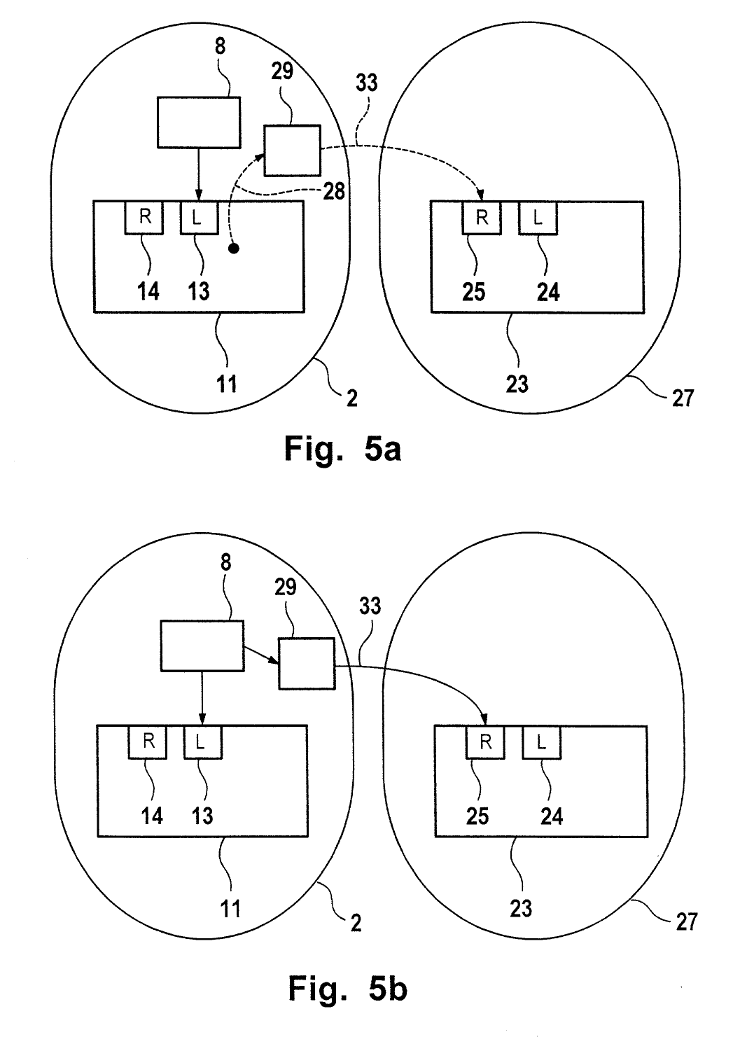

In the second scenario from FIG. 5a the collocated client 8 via the local gate 13 accesses the component 11. The other component 23 is located in another computer 27 or in another computer network node or in an execution environment other than the component 11. The component 11 has a reference 28 to a proxy 29. The proxy 29 converts the local reference 28 into a remote reference 33 to the remote gate 25 of the remote other component 23. This reference 28 is transferred to or from the client 8 which accesses the other component 23 via the proxy 29 and a reference 33 and the remote gate 25 (compare FIG. 5b). In the second scenario likewise no transformation of the reference parameters takes place since the other component 23 is remote both with respect to the component 11 and also with respect to the client 8. The connection from the client 8 to the component 11 need not necessarily continue when the connection is set up via the reference 33. The references 33 can also be established via another proxy instead of via the proxy 29.

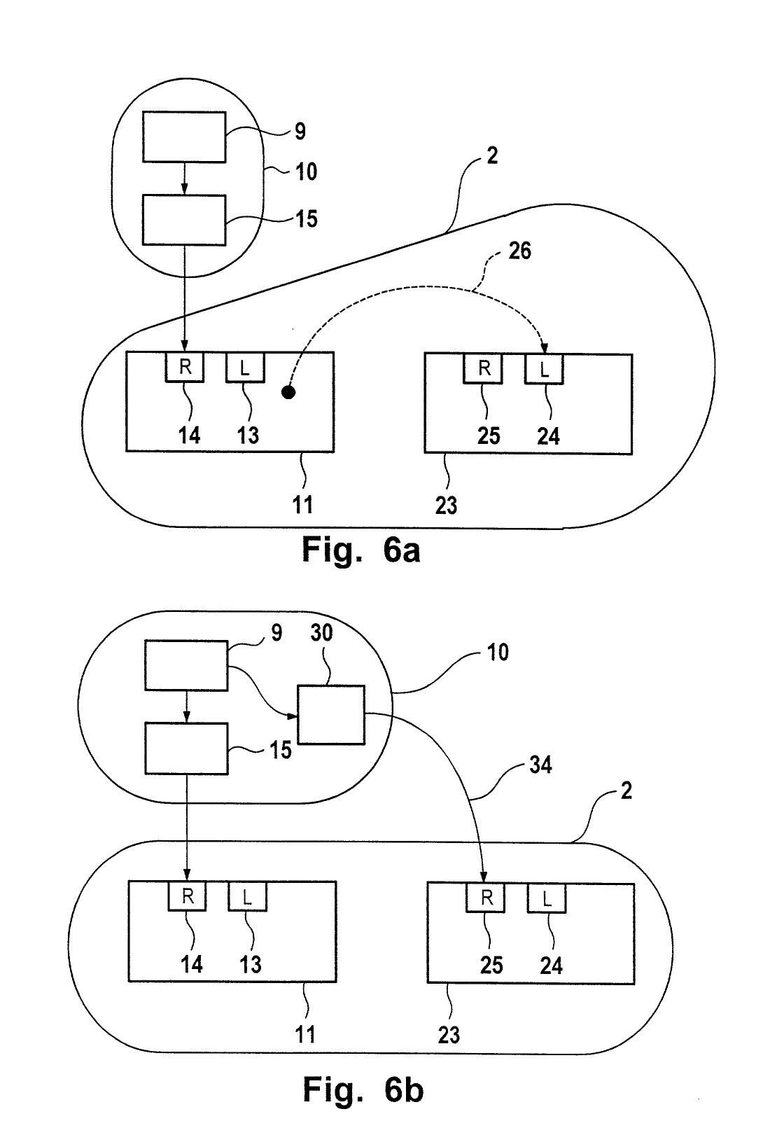

In the third scenario from FIG. 6a the remote client 9 accesses the component 11 via the proxy 15 and the remote gate 14. The other component 23 is located in the same computer 2 or in the same computer network node and in the same execution environment as the component 11. The component 11 has a reference 26 to the local gate 24 of the local other component 23. If the reference 26 is transferred to or from the client 8, it must be transformed into or out of a reference to the proxy 30 which accesses the other component 23 via a reference 34 and the remote access 25 (compare FIG. 6b) . In the third scenario the reference parameters are transformed in the remote gate 14 since the other component 23 is local with respect to the component 11, but remote with respect to the client 9. The reference parameters are therefore transformed by the remote gate 14 from local to remote or vice versa. The connection from the client 9 via the proxy 15 to the component 11 need not necessarily continue when the connection is set up via the proxy 30.

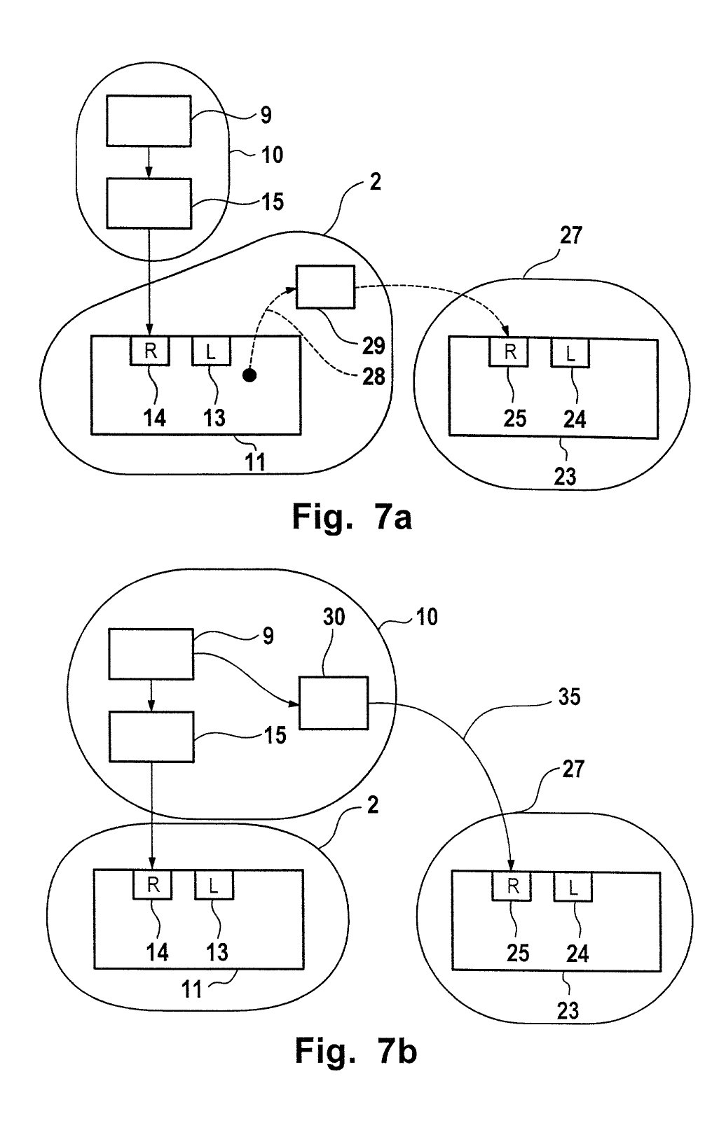

In the fourth scenario from FIG. 7a, the remote client 9 accesses the component 11 via the proxy 15 and the remote gate 14. The other component 23 is located in another computer 27 or in another computer network node or in an execution environment other than the component 11. The component 11 has a reference 28 to the proxy 29. The latter converts the reference 28 into a reference to the remote gate 25 of the remote other component 23. This reference 28 is transferred to or from the client 9 which accesses the other component 23 via a proxy 30, a reference 35 and the remote gate 25 (compare FIG. 7b). In the fourth scenario there is no transformation of reference parameters since the other component 23 is remote both with respect to the component 11 and also with respect to the client 9. The connection from the client 9 via the proxy 15 to the component 11 need not necessarily continue when the connection is set up via the reference 35.

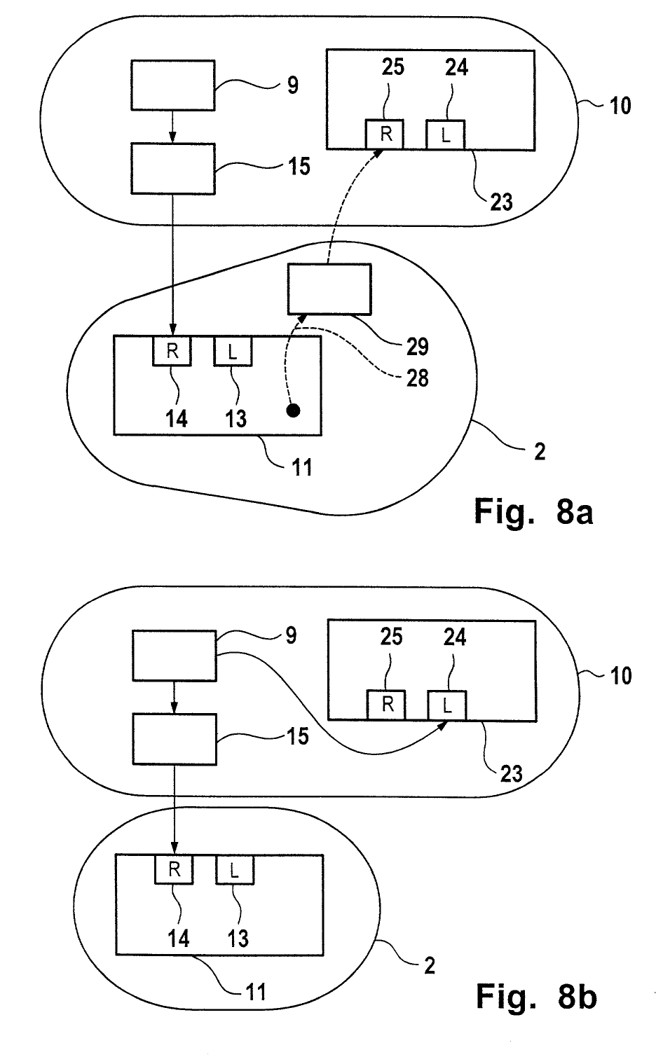

FIG. 8a shows a special case of the fourth scenario shown in FIGS. 7a and 7b in which the other component 23 is indeed remote with respect to the component 11, but is collocated with respect to the client 9, i.e. the client 9 and the other component 23 are located in the same computer 10 or computer network node or in the same execution environment. In this case the proxy 15 must transform remote reference parameters or results of operations into local ones or vice versa so that the client 9 can access the other component 23 via the local gate 24.

If for example the proxy 15 has triggered an operation at the remote gate 14 of the component 11 and as a result obtained a reference to the proxy 29, it should convert the remote reference into a local reference and transfer a local reference. The client 9 which obtains the reference to the proxy 29 would work correctly even without a transformation of the reference, but would take much longer for access to the other component 23 since access to the other component 23 would be processed as a remote access. Without a transformation of the reference, additional, time-consuming functionalities which are necessary for a remote invocation (so-called remote invocation overhead) would have to be carried out, although the client 9 and the other component 23 are collocated. To prevent this, the proxy 15 transforms the reference to the proxy 29 into a local reference and transfers it to the client 9.

Under certain assumptions the process as claimed in the invention can be implemented especially easily. In particular, the transformation of reference parameters (compare embodiments from FIG. 6b and FIG. 8a) can be avoided by certain assumptions. Moreover, under certain conditions a remote gate and a proxy can be abandoned. As one assumption the components (or clients) of the process as claimed in the invention are divided into clusters of closely interworking components. As another assumption all components of a cluster are assigned to the same computer network nodes. In EJBs a cluster with several components is thus assigned to the same virtual machine and generally also to the same container.

A cluster ordinarily contains facade components which are accessed by clients 9 which are located outside the cluster or are loosely linked to the cluster (for example, a facade component of another cluster or a program like a servlet or a applet) (so-called remote clients 9), and non-facade components which are accessed by clients 8 which are located within the cluster or are closely linked to the cluster (for example, a component of the same cluster) (so-called collocated clients 8).

A facade component has one or more facade interfaces. To access a facade component via a facade interface from one client a corresponding proxy with a reference to the corresponding remote gate is transferred to the client. The clients from which the facade component is accessed are usually located outside the cluster (remote clients 9), but can also be located entirely in the same cluster (collocated clients 8).

A non-facade component has simply one or more interfaces internal to the cluster. To access the interface of a non-facade component internal to the cluster from a client a reference to the corresponding local gate is transferred to the client. The clients 8 from which a non-facade component is accessed are always collocated.

In a first scenario let the components be divided into clusters and each cluster assigned to another computer network node. All accesses to facade interfaces take place by clients which are located outside the clusters and thus via a proxy and a remote gate. In this scenario the proxy and the remote gate thus need not transform the reference parameters and/or the results which themselves represent a reference to another component (hereinafter reference parameters and/or results). Access to interfaces of non-facade components internal to the cluster always takes place directly via a local gate. Therefore in this scenario for non-facade components remote gates and proxies can be abandoned.

As a result, implementation of the process as claimed in the invention can be greatly simplified if it is known beforehand which components are facade components and which components are non-facade components and which interfaces are facade interfaces and which are interfaces internal to the cluster. Therefore an identification of the components and the interfaces is introduced. The identification for the components contains information about whether a component is a conventional component or a part of a cluster. Conventional components are considered these components as claimed in the invention to which the described assumptions and simplifications do not apply. If the component is a part of a cluster, the identification also contains information about whether it is a facade component or a non-facade component. Identification for the interfaces contains information about whether an interface is a conventional interface, a facade interface or an interface internal to the cluster. In EJBs a so-called deployment descriptor can be used to identify the components and their interfaces.

In the described simplification, problems could arise if a facade interface were to execute an operation with a reference parameter or a result of the type of an interface internal to a cluster, since a reference to an interface internal to a cluster could be relayed for access to a client which is located outside of the cluster. Therefore this is prevented and it is watched that the operations of a facade interface as the reference parameter and as a result have only those of the type of a facade interface.

A conventional component has only conventional interfaces; it is not assigned to a cluster and works as described above with reference to FIGS. 1a to 8b. The rules and features for components which are located in the clusters and their interfaces are the following:

a) A non-facade component has only interfaces internal to the cluster.

b) A facade-component has facade interfaces and can also have interfaces internal to the cluster.

c) The reference parameters and the results of the operations of a facade interface are of the facade interface type.

d) A client which accesses a component via a facade interface always executes access via a reference to a proxy which has a reference to a remote gate and implements the facade interface. The client can be remote or collocated.

e) The facade interface of a component is always accessed via a remote gate and a proxy which do not transform the reference parameters or the result.

f) Reference parameters and results of operations of an interface internal to the cluster are conventionally of the type of an interface internal to the cluster, but can also be of the facade interface type.

g) A client which accesses a component via an interface internal to the cluster is always collocated and executes access via a reference to the local gate which implements the interface internal to the cluster.

h) For an interface internal to the cluster the component makes available only a local gate, but not a remote gate and no proxies.

It is not necessary for the clusters to be assigned to different computer network nodes. If several clusters are collocated, access takes place from one cluster to the facade interface of a facade component of another cluster via proxies. This yields complete location transparency of the clusters. Under certain circumstances saving the transformation of reference parameters and results yields less processing performance compared to conventional components which are not located in clusters. Saving remote gates and proxies for interfaces internal to the cluster yields the limitation that interfaces internal to the cluster cannot be accessed by remote clients.

The great advantage which accrues when the components are assigned to clusters in the process as claimed in the invention is that the facade interfaces and the interfaces internal to the cluster both follow the same local programming model. Complete location transparency is also preserved in the components which are assigned to clusters: Observing the aforementioned rules an interface internal to the cluster can be converted into a facade interface without the existing clients having had to be modified, and an interface internal to the cluster or a facade interface into a conventional interface; a non-facade component can be converted into a facade component and a facade component or a non-facade component can be converted into a conventional component without further modifications.

The factory of a facade component has a facade-factory interface if the component has interfaces internal to the cluster, also a factory interface internal to the cluster. The factory of a non-facade component has only one factory interface internal to the cluster. In EJB the factory is called the home interface. A naming and directory service for clients which are not collocated with a component returns the reference to a facade-factory interface and otherwise the one to the factory interface internal to the cluster. In EJB the naming and directory service is called the JNDI (Java Naming and Directory Interface).

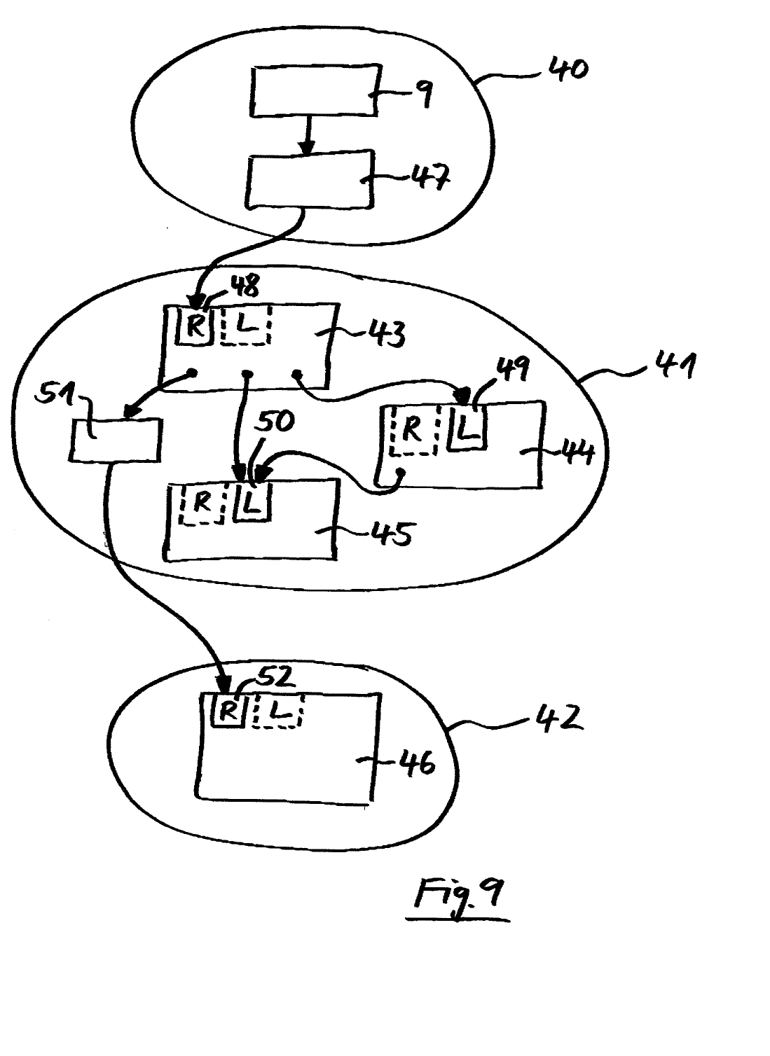

FIG. 9 shows three different clusters 40, 41, 42. The first cluster 40 comprises a remote client 9. The second cluster 41 comprises a facade component 43 with a facade interface and two non-facade components 44, 45 with two interfaces internal to the cluster. The third cluster 42 comprises a facade component 46 with one facade interface.

The client 9 via the proxy 47 accesses the remote gate (R) 48 for the facade interface of the facade component 43. The facade component 43 via a local gate (L) 49 accesses the interface of the first non-facade component 44 internal to the cluster. The non-facade component 44 for its part via a local gate (L) 50 accesses the interface of the second non-facade component 45 internal to the cluster. The facade component 43 via the local gate 50 accesses the interface of the second non-facade component 45 internal to the cluster. Finally, the facade component 43 via a proxy 51 accesses the remote gate (R) 52 for the facade interface of the facade component 46.

According to the described simplification, the implementation of the remote gates (R) and the corresponding proxies for the interfaces of the non-facade components 44, 45 of the second cluster 41 internal to the cluster can be omitted. Moreover, no references to the local gates (L) for the facade interfaces of the facade components 43 of the first cluster 40 and of the facade components 46 of the third cluster 42 are transferred to the clients. For this reason these gates are shown by broken lines in FIG. 9.

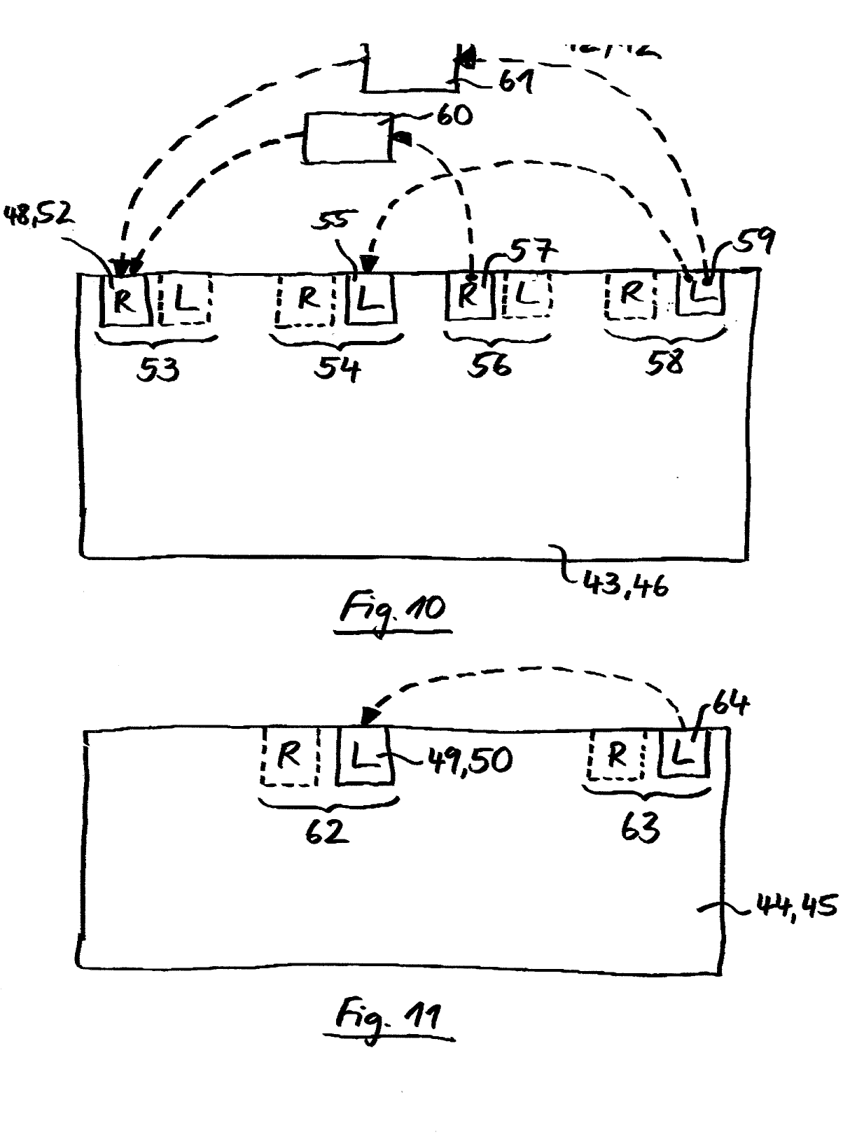

FIG. 10 details one possible embodiment of a facade component 43, 46. It comprises a facade interface 53 and an interface 53 which is internal to the cluster and in which only the local gate (L) 55 is implemented, but the remote gate (R) is not implemented. Furthermore, the component 46 comprises a facade-factory interface 56 which is accessed only via the remote gate (R) 57. Finally, the facade component 46 comprises a factory interface 58 which is internal to the cluster and for which only the local gate (L) 59 is implemented.

The remote gate 57 for the facade-factory interface 56 returns a proxy 60 which refers to the remote gate 48, 52 of the facade interface 53 for the corresponding operations. The local gate 59 for the factory interface 58 internal to the cluster returns a proxy 61 which refers to the remote gate 48, 52 of the facade interface 53. Likewise, the local gate 59 for the factory interface 58 internal to the cluster returns a reference to the local gate 55 of the interface 54 internal to the cluster.

FIG. 11 shows one possible embodiment of a non-facade component 44, 45 in detail. It comprises an interface 60 which is internal to the cluster and in which the remote gate (R) is not implemented, for purposes of simplification. The component 44, 45 furthermore comprises a factory interface 63 which is internal to the cluster and in which only the local gate (L) 64 is implemented, but not the remote gate (R). The local gate 64 for the factory interface 63 internal to the cluster returns a reference to the local gate 49, 50 of the interface 62 internal to the cluster for the corresponding operations.

What is claimed is:

1. A process for operating a distributed computer network comprising a plurality of distributed computers, on one of the computers there being at least one component of a computer program, a component which can run on the microprocessor of the computer, and to operate the computer the at least one component being accessed from a collocated client, or a remote client, the at least one component is accessed from the collocated client via a local gate of the at least one component if the collocated client is filed on the same computer and runs within a same execution environment as the at least one component, and otherwise the at least one component is accessed from the remote client via a remote gate of the at least one component.

2. A process for operating the computer of a distributed computer network comprising the computer and a plurality of distributed computers, on the computer there being at least one component of a computer program, a component which can run on the microprocessor of the computer, and to operate the computer the at least one component is accessed from a collocated client or a remote client, wherein the at least one component is accessed from the collocated client, via a local gate of the at least one component, if the at least one component is filed on the same computer and runs within a same execution environment as the collocated client, and otherwise the at least one component is accessed from the remote client, via a remote gate of the at least one component.

3. The process as claimed in claim 1, wherein from the at least one component, at least one other component is accessed via a local gate of the at least one other component, if the at least one other component is filed on the same computer and runs within the same execution environment as the at least one component and otherwise from the at least one component, the at least one other component is accessed via a remote gate, of the at least one other component.

4. The process as claimed in claim 1, wherein the remote gate of the at least one component is accessed via a proxy, the proxy implementing a same interface as the local gate.

5. The process as claimed in claim 3, wherein the remote gate of the at least one component, is used for transformation of a parameter or a result when services or functionalities of the at least one component have parameters or results which themselves represent a reference to the at least one other component and the at least one other component is located locally with respect to the at least one component, but remotely with respect to the client.

6. The process as claimed in claim 4, wherein the proxy is used for transformation of a parameter or a result when services or functionalities of the at least one component have parameters or results which themselves represent a reference to another proxy and the at least one other component, is located remotely with reference to the at least one component, but collocated with reference to the client.

7. The process as claimed in claim 1, wherein to access the at least one component, first a local naming and directory service is accessed and from it a reference to the at least one component to be invoked is transferred, the reference referring to a local gate of the at least one component if the at least one component to be invoked is a collocated component, and the reference refers via a proxy to a remote gate of the at least one component if the at least one component to be invoked is a remote component.

8. The process as claimed in claim 7, wherein to access the at least one component, first the local naming and directory service is accessed and from it a reference to a factory (19) of the at least one component to be invoked is transferred, the reference referring to the local gate of the factory if the factory and the at least one component to be invoked are collocated, and the reference is packed into a proxy refers to the remote gate of the factory when the factory and the at least one component to be invoked are remote, and another reference to the at least one component to be invoked is transferred by the factory, the at least one other reference referring to a local gate of the at least one component, if the factory and the at least one component to be invoked are collocated, and the other reference is packed into a proxy, refers to a remote gate, of the at least one component if the factory and the at least one component to be invoked are remote.

9. A computer program which can run on a microprocessors of a plurality of computers of a distributed computer network, comprising at least one component, with at least one gate for accessing the at least one component, from a collocated client, which is filed on a same computer, and runs within a same execution environment as the at least one component, or from a remote client, which is filed on another computer and runs within an execution environment other than the at least one component, wherein the at least one component has a local gate for access to the at least one component from the collocated client and a remote gate for access to the at least one component from the remote client.

10. A storage element, selected from a read-only memory, a random access memory, or a flash memory for a computer of a distributed computer network on which at least one component of a computer program which can run on the microprocessors of the computer of the computer network is stored, the at least one component having at least one gate for accessing the at least one component from a collocated client which is filed on a same computer and runs within the same execution environment as the at least one component, or from a remote client which is filed on another computer and runs within an execution environment other than the at least one component, wherein the at least one component has a local gate for access to the at least one component from the collocated client and a remote gate for access to the at least one component from the remote client.

11. A computer of a distributed computer network with a storage element, selected from a read-only memory, a random access memory, or a flash memory on which at least one component of a computer program which can run on the microprocessors of the computers of the computer network is stored, the at least one component having at least one gate for accessing the at least one component from a collocated client which is filed on the same computer and runs within a same execution environment as the at least one component, or from a remote client which is filed on another computer and runs within an execution environment other than the at least one component, wherein the at least one component has a local gate for access to the at least one component from the collocated client and a remote gate for access to the at least one component from the remote client.

12. A distributed computer network comprising several computers with one storage element each, selected from a read-only memory, a random access memory, or a flash memory on which at least one component of a computer program which can run on the microprocessors of the computers of the computer network is stored, the at least one component having at least one gate for accessing the at least one component from a collocated client which is filed on the same computer and runs within the same execution environment as the at least one component, or from a remote client which is filed on another computer and runs within an execution environment other than the at least one component, wherein the at least one component has a local gate for access to the at least one component from the collocated client and a remote gate for access to the at least one component from the remote client.
